(19) United States
(12) Patent Application Publication
(10) Pub. No.: US 2022/0322643 A1
(43) Pub. Date: Oct. 13, 2022

(54) CORAL FARMING METHOD, SYSTEM AND PRODUCT THEREOF

(71) Applicant: Popeye Marine Biotechnology Limited, New Taipei City (TW)

(72) Inventor: YI-JEN SHENG, NEW TAIPEI CITY (TW)

(21) Appl. No.: 17/709,474

(22) Filed: Mar. 31, 2022

(30) Foreign Application Priority Data
Apr. 7, 2021 (TW) 110112541
Mar. 25, 2022 (TW) 111111279

(51) Int. Cl. A01K 61/20; A01K 63/06; A01K 63/04

(52) U.S. Cl. CPC A01K 61/20; A01K 63/06; A01K 63/045

(57) ABSTRACT

The present invention provides a coral farming method, by monitoring the seawater environment in the water tank, providing stable and optimal growth environment and nutrients for small polyp stony corals so as to achieve mass production of small polyp stony corals. The present invention further provides a coral farming system and a coral product. The coral farming system adopts the coral farming method and warrants the stable and good quality of the obtained coral product which is free of heavy metal contaminations.

### CROSS-REFERENCE TO RELATED APPLICATION

Pursuant to 35 U.S.C. § 119(a), this application claims the benefits of the priority to Taiwan Patent Application No. 110112541, filed on Apr. 7, 2021 and Taiwan Patent Application No. 111111279, filed on Mar. 25, 2022, which are incorporated by reference herein by their entirety.

### BACKGROUND OF THE INVENTION

### 1. Field of the Invention

The present invention relates to a coral farming method, especially an indoor coral farming method; the present invention further relates to a coral farming system and a coral product.

### 2. Description of the Prior Arts

Regenerative medicine is under rapid development. As coral bone has a porous structure, which is similar to human bone, it is an emerging natural biomaterial and has a wide medical application in the future.

However, due to the increasing industrial development and commercial activities nowadays, the greenhouse effect has aggravated. Further, both the global climate change resulting in the deterioration of the ecological environment, and the wastewater from factories and the accidental oil spills from marine shipping from time to time are all the direct causes of coral death.

Once the corals are subjected to coral bleaching and coral death in the open ocean, the restoration thereof will be difficult. Besides, natural ecological protection emphasizes ecological diversity, and various ecological factors have complicated interactions, so farming a single species in the open ocean is inappropriate. Therefore, there is an urgent need to develop an indoor farming method for corals.

### SUMMARY OF THE INVENTION

The present invention provides a coral farming method, which can be used for the massive production of small polyp stony corals, the so-called SPS hard corals. The present invention further provides a coral farming system and a coral product.

The term “farming” of the present invention refers to making small polyp stony corals carry out asexual reproduction for coral propagation and coral growth, and sexual reproduction is excluded. Besides, the coral farming method of the present invention is indoor farming for the whole process, which is an artificial propagation method and does not involve any use of a wild coral.

To achieve the aforementioned object, the present invention provides a coral farming method, comprising: providing a water tank, wherein the water tank contains seawater, and the seawater has calcium ions and magnesium ions; an inoculation step, comprising placing a coral on a base, and the base being placed in the water tank; a cultivating step, comprising maintaining the seawater to have a pH of 7.8 to 8.8, a salinity of 29 parts per thousand (ppt) to 37 ppt, an alkalinity of 7 dKH to 10 dKH, and a temperature of 20° C. to 26° C., a calcium ions concentration of 430 ppm to 500 ppm, and a magnesium ions concentration of 1290 ppm to 1500 ppm; a feeding step, comprising providing food to the coral; an illuminating step, comprising providing light to the coral for at least 6 hours a day; and a decontamination step, comprising removing a floating foam of the seawater and based on the total volume of the seawater in the water tank, filtering the seawater in an amount of at least 2.6 volume percent per minute; wherein the coral is a small polyp stony coral.

The present invention provides a stable and best growing environment for small polyp stony corals by monitoring the seawater conditions in the water tank, and provides an illuminant to facilitate the photosynthesis of symbiotic algae, which provides nutrients for small polyp stony corals to grow steadily and to form coral bones. Besides, the filtration facilitating purifying the seawater, and the removal of the floating foam can reduce the organic substance such as proteins and amino acids, etc. in the seawater to refrain small polyp stony corals from death resulting from water quality deterioration.

The coral bone of the present invention is a coral bone of calcium carbonate.

The term “comprise” of the present invention can be substituted for a closed or a partial open-ended transitional term. For example, the term “comprise” can mean “consisting of” or “consisting essentially of.” Unless the transitional term is modified, the statement in this paragraph shall not be used to limit the claimed scope of the claims.

The seawater can be nature seawater or artificial seawater prepared by taking reference to the salt contents comprised in the nature seawater. Preferably, the seawater has a pH of 8.0 to 8.6. More preferably, the seawater has a pH of 8.2 to 8.4. Preferably, the seawater has a salinity of 29.5 ppt to 34 ppt. More preferably, the seawater has a salinity of 29.7 ppt to 32 ppt. Preferably, the seawater has an alkalinity of 8.0 dKH to 9.0 dKH. More preferably, the seawater has an alkalinity of 8.2 dKH to 8.8 dKH. Further preferably, the seawater has an alkalinity of 8.4 dKH to 8.6 dKH. Preferably, the seawater has a temperature of 22° C. to 25.5° C. More preferably, the seawater has a temperature of 23° C. to 25° C.

In one embodiment, the seawater has a depth of 10 cm to 50 cm. Preferably, the seawater has a depth of 30 cm to 40 cm. More preferably, the seawater has a depth of 35 cm. Although the growing environment provided by the seawater in a shallow tank is more vulnerable to rapid change in comparison with that in a deep tank, by adopting the farming method of the present invention, the coral can still grow steadily and it is easier to harvest in a shallow tank.

Preferably, the coral is selected from the group consisting of Acropora Formosa, Acropora nobilis, Acropora austere, Acropora valenciennesi, Acropora pulchra, Acropora microphtha, Acropora intermedia and Acropora florida, and is not limited thereto.

The Acropora formosa has a synonym of Acropora muricata.

The corals of different species are farmed in separate tanks or in substantially separated areas. If the corals of different species are farmed together in the same tank, they will respectively pursue their own needs, making the ideal aquarium water parameters easier to maintain. However, according to the present invention, it will induce symbiotic algae to leave some of the corals and result in coral bleaching. In comparison, as corals of the same species have the same optimal growth conditions, the nutrient consumption and waste production thereof are all the same, which results in the growing environment provided by the seawater being vulnerable to a rapid change, which brings more difficulties to maintain the ideal aquarium water parameters and constitutes a higher technical threshold for farming single species in one tank. Finally, the approach to farm corals of different species in separate tanks or in substantially separated areas can avoid the growth space competition between different species.

Preferably, the coral is a coral fragment, and the coral fragment comprises a calcium carbonate fragment and coral polyps. As coral polyps lacking symbiotic algae will result in coral bleaching and coral death, the coral polyps of the present invention comprise symbiotic algae.

In one embodiment, the calcium carbonate fragment has a length of 0.2 cm to 4 cm. Preferably, the calcium carbonate fragment is in the form of a particle, which the calcium carbonate fragment is a calcium carbonate particle, and the calcium carbonate particle has a particle size of 0.2 cm to 0.5 cm. More preferably, the calcium carbonate particle has a particle size of 0.3 cm to 0.4 cm.

The coral fragment can be in the form of a dot, which is obtained from any part of the propagated parental coral, or the coral fragment is a segment, which is a broken branch of the propagated parental coral.

The smaller the calcium carbonate particle is, the lower the survival rate of the coral polyps in the early stage after inoculation will be. The present invention accurately controls the environment in the seawater, so the size of the calcium carbonate particle can be greatly reduced, while the steady growth of the coral fragment is warranted at the same time.

Preferably, the coral fragments have a density of 50 to 60 coral fragments per square meter.

Preferably, based on the total volume of the seawater in the water tank, the step of filtering the seawater is in an amount of 2.6 volume percent per minute to 8.6 volume percent per minute. More preferably, the step of filtering the seawater is in an amount of 4.5 volume percent per minute to 6.6 volume percent per minute. Further preferably, the step of filtering the seawater is in an amount of 5 volume percent per minute to 6.1 volume percent per minute. The total volume of the seawater in the water tank indicates the actual volume of the seawater contained in the water tank. As the water tank is also used to accommodate small polyp stony corals for providing a growing environment, the total volume of the seawater in the water tank does not include the seawater in the pipelines or other tanks, such as: a filter tank or a water storage tank, etc. The present invention provides a sufficiently high volume percentage of the filtered water so as to not only warrant water quality, but also secure the flow of the seawater in the water tank to avoid coral death.

SPS hard corals generally survive in the environment with nutrient salts at low concentration only. That is, the concentration of the calcium ions is 420 ppm or less, and the concentration of the magnesium ions is 1260 ppm or less, otherwise coral bleaching and coral death will easily occur. The present invention controls the filtered amount of the seawater, so that SPS hard corals farmed at a high density can survive and grow fast in the environment with high concentration of calcium ions and magnesium ions.

Preferably, the base comprises a ceramic base plate or a cement plate. In one embodiment, the ceramic base plate or the cement plate is cylindrical.

According to the present invention, the adoption of a cylindrical ceramic base plate can reduce algae attachment to refrain the growing space of the coral polyps from the invasion of other algae. The ceramic base plate has tiny three-dimensional holes, which facilitate the growth of nitrifying bacteria, aerobic bacteria and facultative anaerobic bacteria, and reduce nitrate, nitrite and phosphate in the seawater.

Preferably, the seawater comprises phosphate, nitrate and nitrite, and the concentration of the phosphate is 0 ppm or more and less than 0.03 ppm, the concentration of the nitrate is 0 ppm or more and less than 0.5 ppm, and the concentration of the nitrite is 0 ppm or more and less than 0.1 ppm. The “0 ppm” indicates not detected.

Excessively high concentrations of phosphate, nitrate and nitrite will result in overgrowth of algae, which jeopardizes the maintenance of a clean seawater.

Preferably, the concentration of the calcium ions is 450 ppm to 480 ppm.

Preferably, the concentration of the magnesium ions is 1370 ppm to 1420 ppm.

According to the present invention, the concentration of the calcium ions and the magnesium ions as well as the alkalinity within certain range facilitate small polyp stony corals to secrete calcium carbonate to form bones. If the concentrations of the calcium ions and the magnesium ions as well as the alkalinity are excessively high, crystals easily form in the water tank. If the concentration of the calcium ions and the magnesium ions as well as the alkalinity are too low for a long period, the color of the coral gets darker followed by coral death.

Preferably, the light is provided 9 hours per day to 13 hours per day. More preferably, the light is provided 10 hours per day to 12 hours per day.

The illumination time can be provided continuously or without interruption.

In one embodiment, the frequency to monitor the seawater is 5 times per day to 12 times per day. Preferably, the frequency to monitor the seawater is 8 times per day to 12 times per day, such as 10 times per day. Preferably, the light is provided from a light source selected from the group consisting of a white light of 2800K to 3800K, a white light of 5000K to 6500K, a blue light of 425 nm to 435 nm, and a blue light of 445 nm to 470 nm.

According to the present invention, the light source or its combination can control the amount of polyps and symbiotic algae. Therefore, the use of different combinations of various light sources can further control the growing rate of the small polyp stony corals, and guide the small polyp stony corals to distribute evenly.

In one embodiment, the frequency to provide food is 8 times per day to 15 times per day. Preferably, the frequency to provide food is 1 time a week to 3 times a week.

Preferably, the food comprises a rotifer, paramecium or a combination thereof. The rotifer provided in the present invention can make the coral bone thicker and stronger.

In one embodiment, the rotifer comprises small (S-type) rotifer or super small (SS-type) rotifer or a combination thereof.

The small (S-type) rotifer has a length of 100 micrometers to 210 micrometers. Preferably, the small (S-type) rotifer has a length of 100 micrometers to 120 micrometers. The super small (SS-type) rotifer has a length of 90 micrometers to 110 micrometers.

In one embodiment, the small (S-type) rotifer has an average length about 160 micrometers.

In one embodiment, the rotifer comprises Brachionus rotundiformis or Brachionus ibericus or a combination thereof.

The small polyp stony coral has a main body and branches. According to the present invention, the vertical height of the whole plant of the small polyp stony corals can increase 0.5 cm to 0.8 cm per month; the length of the branch thereof can increase 0.3 cm to 1 cm per month. The diameter of the main body of the small polyp stony corals can increase 0.05 cm to 0.15 cm per month, and the diameter of the branch of the small polyp stony corals can increase can increase 0.05 cm to 0.8 cm per month. The branch of the small polyp stony corals is thinner, so the maximum growing rate thereof can be higher than that of the vertical height of the whole plant.

Preferably, the coral fragments are farmed for 500 days to 600 days to obtain a whole plant of the coral; wherein the vertical height of the whole plant of the coral is 12 cm to 20 cm, the length of the branch is 5 cm to 15 cm, the diameter of a main body is 1.5 cm to 3.5 cm, and the diameter of a branch is 0.6 cm to 1.5 cm. More preferably, the vertical height of the main body of the whole plant of the coral is 15 cm to 20 cm, the length of the branch is 6 cm to 15 cm, the diameter of the main body is 1.6 cm to 3.5 cm, and the diameter of the branch is 0.8 cm to 1.5 cm.

The present invention further provides a coral farming system, comprising: a seawater, wherein the seawater has calcium ions and magnesium ions, and the seawater has a pH of 7.8 to 8.8, a salinity of 29 parts per thousand (ppt) to 37 ppt, an alkalinity of 7 dKH to 10 dKH, a temperature of 20° C. to 26° C., a calcium ions concentration of 430 ppm to 500 ppm, and a magnesium ions concentration of 1290 ppm to 1500 ppm; a water tank, wherein the water tank is used for containing the seawater, at least one base is provided to the bottom in the water tank, the at least one base is used for placing a coral, and based on the total volume of the seawater in the water tank, the filtered amount of the seawater is at least 2.6 volume percent per minute; a light source module, used for providing light to the coral for at least 6 hours a day; a water cleaning module, used for filtering the seawater; a defoaming module, used for removing a floating foam of the seawater; a pure water supply module, used for supplying a pure water to supplement the seawater and having a water supply outlet; and a water storage tank, having a water inlet and a water outlet, wherein the water inlet and the water outlet each communicate to both the water tank and the water storage tank, and the water supply outlet communicates to both the pure water supply module and the water storage tank.

The coral farming system of the present invention adopts the coral farming method.

Preferably, each base is placed with a single coral.

Preferably, the light source module is provided at 40 cm to 150 cm above the surface of the seawater.

Preferably, the water storage tank is set below the water tank or below the bottom of the water tank.

Preferably, the pure water supply module further has a pure water outlet control module, used for opening or closing the water supply outlet. More preferably, the water supply outlet is near the water outlet.

The pure water supply module can be cold RO water purifier; and the pure water can be a reverse osmosis water.

Preferably, the water cleaning module is contained in the water storage tank.

Preferably, the coral, the seawater, the base, the light source module, the illumination time and the filtered amount of the seawater are the same as those in the coral farming method.

Preferably, the water cleaning module comprises a biochemical cotton, a ceramic ring, a filter cotton, coral bone stones and live rock of coral reefs.

The biochemical cotton can be used to cultivate nitrifying bacteria, aerobic bacteria and facultative anaerobic bacteria, and strengthen the absorption of harmful substances. The ceramic ring can also provide an excellent proliferation and growing environment for nitrifying bacteria, aerobic bacteria and facultative anaerobic bacteria. The filter cotton serves as the main filter cotton in the water cleaning module, and is used to filter the feces and impurities produced by corals, fish and algae in the water tank. The coral bone stones can keep calcium ions concentration and filter the seawater. The live rock of coral reefs provides a stable ecological environment for the microorganisms and forms an independent biological chain, which facilitates the growth of nitrifying bacteria, aerobic bacteria and facultative anaerobic bacteria, reduces the concentration of both nitrate and phosphate, and releases organic matter for corals and other microorganisms to uptake.

Preferably, the storage volume ratio of the water tank and the water storage tank is 4 to 5:1. According to the present invention, the water storage tank has a water cleaning module for purifying the seawater, and provides a sufficient amount of clean seawater, which facilitates a real time adjustment for water quality to warrant the yield and quality of the small polyp stony corals.

The present invention further provides a coral product, comprising a calcium ingredient and a magnesium ingredient; and having a plurality of pores; wherein the calcium ingredient comprises calcium, the magnesium ingredient comprises magnesium, and based on the total amount of metal element and nonmetal element comprised in the coral product, the calcium is in an amount of 95 weight percent or more, the magnesium is in an amount of 1 weight percent or less, and the metal element comprises calcium, magnesium, potassium, iron and sodium, and the nonmetal element comprises phosphorus.

In one embodiment, the metal element comprises lead, cadmium, mercury, copper, calcium, magnesium, potassium, zinc, iron, manganese and sodium; and the nonmetal element comprises arsenic, phosphorus and selenium.

In one embodiment, the metal element comprises lead, cadmium, mercury, copper, calcium, magnesium, potassium, zinc, iron, manganese and sodium; and the nonmetal element comprises silicon, arsenic, phosphorus and selenium.

The elements listed in the metal element and nonmetal element are test items and included in the denominator for calculating the total amount of metal element and nonmetal element, which does not mean that the coral product of the present invention actually comprises each of the listed elements.

Preferably, based on the total amount of metal element and nonmetal element comprised in the coral product, the calcium is in an amount of 98 weight percent to 99 weight percent.

Preferably, based on the total amount of metal element and nonmetal element comprised in the coral product, the magnesium is in an amount of 0.15 weight percent to 0.35 weight percent. Preferably, the magnesium is in an amount of 0.19 weight percent to 0.35 weight percent. More preferably, the magnesium is in an amount of 0.2 weight percent to 0.22 weight percent, or 0.3 weight percent to 0.35 weight percent.

In one embodiment, the coral product further comprises a phosphorus ingredient, and the phosphorus ingredient comprises phosphorus, and based on the total amount of metal element and nonmetal element comprised in the coral product, the phosphorus is in an amount of 0.005 weight percent to 0.010 weight percent. Preferably, the phosphorus is in an amount of 0.0065 weight percent to 0.008 weight percent. More preferably, the phosphorus is in an amount of 0.0065 weight percent to 0.0076 weight percent, such as: 0.0065 weight percent, 0.0067 weight percent, 0.0070 weight percent, 0.0072 weight percent, 0.0075 weight percent or 0.0076 weight percent.

In one embodiment, the coral product further comprises a potassium ingredient, and the potassium ingredient comprises potassium, and based on the total amount of metal element and nonmetal element comprised in the coral product, the potassium is in an amount of 0.015 weight percent to 0.030 weight percent. Preferably, the potassium is in an amount of 0.017 weight percent to 0.030 weight percent. More preferably, the potassium is in an amount of 0.019 weight percent to 0.021 weight percent, or 0.027 weight percent to 0.028 weight percent.

In one embodiment, the coral product further comprises an iron ingredient, and the iron ingredient comprises iron, and based on the total amount of metal element and nonmetal element comprised in the coral product, the iron is in an amount of 0.002 weight percent to 0.11 weight percent. Preferably, the iron is in an amount of 0.0025 weight percent to 0.1 weight percent. More preferably, the iron is in an amount of 0.0030 weight percent to 0.0034 weight percent, or 0.095 weight percent to 0.098 weight percent.

In one embodiment, the coral product further comprises a sodium ingredient, and the sodium ingredient comprises sodium, and based on the total amount of metal element and nonmetal element comprised in the coral product, the sodium is in an amount of 0.5 weight percent to 2 weight percent. Preferably, the sodium is in an amount of 1.0 weight percent to 1.4 weight percent. More preferably, the sodium is in an amount of 1.0 weight percent to 1.2 weight percent.

In one embodiment, the coral product further comprises a silicon ingredient, and the silicon ingredient comprises silicon, and based on the total amount of metal element and nonmetal element comprised in the coral product, the silicon is in an amount of 0.05 weight percent to 0.15 weight percent. Preferably, the silicon is in an amount of 0.07 weight percent to 0.12 weight percent. More preferably, the silicon is in an amount of 0.09 weight percent to 0.1 weight percent.

In one embodiment, each of arsenic, lead, cadmium, mercury, copper, zinc, manganese and selenium is not detected in the coral product, or in an amount of 0 weight percent to less than 0.001 weight percent. More preferably, each of the arsenic, lead, cadmium, mercury, copper, zinc, manganese and selenium is in an amount of 0 weight percent to less than 0.0007 weight percent.

In one embodiment, based on the total amount of metal element and nonmetal element comprised in the coral product, the total amount of the calcium, sodium and magnesium is 99.5 weight percent or more. Preferably, the phosphorus is in an amount of 0.010 weight percent or less; the potassium is in an amount of 0.030 weight percent or less; the iron is in an amount of 0.11 weight percent or less; and/or the silicon is in an amount of 0.15 weight percent or less. More preferably, the silicon is in an amount of 0.1 weight percent or less.

The calcium ingredient can be calcium carbonate (CaCO₃).

The magnesium ingredient can be magnesium carbonate (MgCO₃).

In one embodiment, the coral product is obtained by processing the small polyp stony corals. The small polyp stony corals serve as a raw material. The term “processing” can indicate changing an appearance of the raw material through mechanical approach; and/or changing the composition or properties of the raw material through chemical approach.

In one embodiment, the coral product is a block. The block indicates it is a single piece and is not formed by jointing or linking a plurality of mutually independent pieces. Preferably, the coral product is a bone block. More preferably, the bone block substantially comprises calcium carbonate.

Preferably, the coral product is a geometrical object with a length, width and height of 0.2 cm to 12 cm, respectively.

In one embodiment, the geometrical object is a cuboid with a length of 0.3 cm to 5 cm, a width of 0.2 cm to 3.5 cm; and a height of 0.2 cm to 3.5 cm.

In one embodiment, the geometrical object is a cube with a length, width and height of 0.2 cm to 3.5 cm, respectively.

In one embodiment, the geometrical object is a spheroid with a diameter of 0.2 cm to 3.5 cm.

In one embodiment, the geometrical object is a cylinder with a diameter of 0.2 cm to 3.5 cm, and a height of 0.5 cm to 7 cm, such as 5 cm.

Preferably, the coral product is in the form of a particle and has a particle size of at least 250 μm or more than 2000 μm. More preferably, the particle size thereof is 250 μm to 5000 μm, such as: 250 μm, 500 μm, 1000 μm, 2000 μm, 3000 μm, 4000 μm or 5000 μm.

The coral product is prepared by using the coral obtained from the coral farming method or the coral farming system, wherein the coral has a bone, and the coral product is obtained by processing the bone.

Preferably, the pore indicates a hole located on the surface of the coral bone and a channel located inside the coral bone, and the hole communicates with the channel. More preferably, there are a plurality of channels which communicate with each other to form complex inner interconnected channels. Further preferably, the pores are formed during the growth of the coral, and not formed by mechanical or chemical approach after the coral bone is obtained.

In one embodiment, the average compressive strength of the coral product is 50 kgf to 200 kgf. Preferably, the average compressive strength of the coral product is 90 kgf to 150 kgf, such as: 90 kgf, 100 kgf, 110 kgf, 120 kgf, 130 kgf, 140 kgf or 150 kgf. More preferably, the average compressive strength of the coral product is 95 kgf to 110 kgf. The average compressive strength in the present invention is the average maximum compressive load.

In one embodiment, the average compressive strength is obtained according to the regulations of ISO 13175-3(2012). Preferably, the average diameter of the coral product is 10.1 mm, the average height thereof is 15.1 mm, the test speed is 0.50 mm/min, the diameter of the steel ball used in the test is 12.7 mm, and/or the equipment used in the test is Universal Testing Machine, such as: Criterion C43 Universal Testing Machine, and the brand name thereof is MTS.

In one embodiment, the average diameter of the pore of the coral product is 0.5 micrometers to 1.7 micrometers. Preferably, the average diameter of the pore of the coral product is 0.7 micrometers to 1.2 micrometers, such as: 0.7 micrometers, 0.8 micrometers, 0.9 micrometers, 1.0 micrometers, 1.1 micrometers or 1.2 micrometers. More preferably, the average diameter of the pore of the coral product is 0.85 micrometers to 1.05 micrometers.

In one embodiment, the average diameter of the pore is obtained according to the regulations of ISO 13175-3(2012). Preferably, the coral product is in the form of a particle, such as powders. Further, the diameter of the pore is measured in a field of view magnified by 4000 times. In other words, after 4000× magnification, what cannot be judged as a pore is not measured.

In one embodiment, the average distance between the two centers of the respective two pores of the coral product is 5 μm to 10 μm. Preferably, the average distance between the two centers of the respective two pores of the coral product is 6 μm to 9 μm, such as: 6 μm, 7 μm, 8 μm or 9 μm. More preferably, the average distance between the two centers of the respective two pores of the coral product is 6.8 μm to 7.6 μm.

In one embodiment, the standard deviation of the average distance between the two centers of the respective two pores of the coral product is less than half of the average distance between the two centers of the respective two pores of the coral product. Preferably, the standard deviation of the average distance between the two centers of the respective two pores of the coral product is higher than 0 and less than one third of the average distance between the two centers of the respective two pores of the coral product, such as: less than one fourth or one fifth of the average distance between the two centers of the respective two pores of the coral product.

In one embodiment, the average distance between the two centers of the respective two pores of the coral product is obtained by measuring the coral product in the form of a particle, such as powders. Further, the diameter of the pore is measured in a field of view magnified by 4000 times. In other words, after 4000× magnification, what cannot be judged as a pore is not measured. Preferably, 10 adjacent pores are selected in a field of view magnified by 4000 times, and the diameters of the pores are all more than 0 micrometer and equal to or less than 5 micrometers.

In one embodiment, the crystallinity of the coral product is 79% to 81%, and the amorphous thereof is 19% to 21%. Preferably, the crystallinity of the coral product is 79.9%, and the amorphous thereof is 20.1%. Therefore, the coral product of the present invention has a high proportion of crystals.

The small polyp stony corals obtained by the coral farming method of the present invention grow in a stable indoor circulation system, and is not subjected to the various environmental change, pollution and infection outdoors or in the open ocean. Therefore, the coral bone obtained from the small polyp stony corals has the size, density and ingredients, which can be accurately controlled and is stable and suitable for standardization, and is further free of the problems of the outdoor nature coral bone: the possibility of containing heavy metals, a diverse diameter size of the holes of the inner connecting channel, uneven distribution of the pores and the coral hollow issue. In other words, the coral bone of the small polyp stony corals of the present invention has a structure and ingredients which are all different from those of natural corals, and has novelty.

To sum up, the present invention monitors the seawater environment in the water tank, provides stable and optimal growth environment and nutrients for small polyp stony corals so as to achieve mass production of small polyp stony corals. Besides, the coral farming method of the present invention is fulfilled by the coral farming system, and warrants the stable and good quality of the obtained coral product.

### BRIEF DESCRIPTION OF THE DRAWINGS

FIG. 1 is a schematic diagram of the coral farming system.

FIG. 2A and FIG. 2B are the photos of the coral of the present invention.

FIG. 3A to FIG. 3C are the photos of the bone blocks of the coral of the present invention.

FIG. 4 is the photo of the test sample of the coral bone of the present invention.

FIG. 5A is the photo of the powders of the coral bone of the present invention; FIG. 5B is the 500× photo of the particle of the coral bone of the present invention; FIG. 5C and FIG. 5D are the 4000× photo of the particle of the coral bone of the present invention.

### DETAILED DESCRIPTION OF THE PREFERRED EMBODIMENTS

The present invention is further explained through the following embodiments. A person having ordinary skill in the art can easily understand the advantages and efficacies achieved by the present invention. The present invention should not be limited to the contents of the embodiments. A person having ordinary skill in the art can make some improvement or modifications which are not departing from the spirit and scope of the present invention to practice or apply the content of the present invention.

### Example 1: The Coral Farming Method

The coral was propagated in a glass culturing tank within a building in a closed system with circulating seawater, which means that the glass culturing tank did not communicate with the open sea to directly draw or discharge seawater. The seawater of the present invention was obtained from natural sea, which required sedimentation and purification first, and then the parameters of the seawater as described later were adjusted within the predetermined range. The coral comprised Acropora formosa, Acropora nobilis, Acropora austere, Fimbriaphyllia ancora, Spinal wheat soft coral (Dendronepythya sp.) and Sea crest coral (Dendronepythya sp.), each of which was propagated in separate glass culturing tanks. Fimbriaphyllia ancora, Spinal wheat soft coral (Dendronepythya sp.) and Sea crest coral (Dendronepythya sp.) were not small polyp stony corals and served as a reference for comparison. All the corals in the present invention were obtained by artificial propagation, not wild coral.

First, a coral fragment in the form of a dot was taken from the propagated parental coral, and the coral fragment in the form of a dot comprised a calcium carbonate particle and coral polyps, and the particle diameter of the calcium carbonate particles was about 0.2 cm to 0.5 cm. The coral fragment in the form of a dot was inoculated and fixed on a cylindrical ceramic base plate or a cement plate to facilitate the growth of the coral fragments, and the density of the coral fragments in the form of a dot was 50 to 60 per square meter. During inoculation, the coral fragments in the form of a dot only left the seawater shortly. Further, the coral polyps comprised symbiotic algae.

After the inoculation of the coral fragments was completed, rotifers were provided as food and coral feeding was carried out 1 to 3 times a week, and continuous monitoring of the water quality and aquarium water parameters of the circulating seawater was carried out at a frequency of 8 to 12 times a day. Automatic replenishment and a water purification module were set to maintain the circulating seawater with a pH of 7.8 to 8.8, a salinity of 29 ppt to 37 ppt, an alkalinity of 7 dKH to 10 dKH, a temperature of 20° C. to 26° C., a phosphate concentration that was less than 0.03 ppm, a nitrate concentration that was less than 0.1 ppm, a nitrite concentration that was less than 0.1 ppm, a calcium ions concentration of 430 ppm to 500 ppm, and a magnesium ions concentration of 1290 ppm to 1500 ppm.

A water storage tank was set below the glass culturing tank to store filtered clean seawater and was equipped with a water purification module. The water purification module comprised a biochemical cotton with a pore size of 0.1 mm, a biochemical cotton with a pore size of 0.3 mm, a ceramic ring with a pore size of 0.01 mm to 0.05 mm, a filter cotton with a pore size of 0.1 mm to 0.3 mm, coral bone stones and live rock of coral reefs to quickly process and control the water quality of the circulating seawater. Besides, the floating foam on the surface of the circulating seawater was removed by the protein skimmer to reduce the organic substance such as proteins and amino acids, etc. produced by the coral.

The light-emitting diodes (LED) comprising a white LED of 2800K to 3800K, a white LED of 5000K to 6500K, a blue LED of 425 nm to 435 nm, and a blue LED of 445 nm to 470 nm were used. The light was provided at intervals, and the illumination time was 12 hours in total per day to facilitate the photosynthesis of symbiotic algae. Finally, the filtered amount of the seawater was 5.56 volume percent based on the total volume of the seawater in the glass culturing tank, which did not include those in the water storage tank and the pipelines.

Comparative Experiments

The parameter differences among different coral farming conditions and the corresponding results were elaborated as follows:

O: indicating that the growth of corals was in good condition.

X: indicating that coral death or water quality deterioration occurred.

Δ: indicating that the growth of corals was not good or the growth rate thereof slowed down.

Experiment 1: pH

The farming conditions in each group in this experiment were similar to those in Example 1, and the difference was the pH only. The results were shown in Table 1.

TABLE 1
The farming results of different pH

| | 7.7 | 7.8 | 8.3 | 8.8 | 8.9 |
|---|---|---|---|---|---|
| Acropora | Δ | ◯ | ◯ | ◯ | Δ |
| formosa | | | | | |
| Acropora | Δ | ◯ | ◯ | ◯ | Δ |
| nobilis | | | | | |
| Acropora | Δ | ◯ | ◯ | ◯ | Δ |
| austere | | | | | |
| Fimbriaphyllia | Δ | ◯ | ◯ | X | X |
| ancora | | | | | |

According to Table 1, when the pH was 7.8 to 8.8, it was most suitable for the growth of Acropora formosa, Acropora nobilis and Acropora austere.

Experiment 2: Salinity

The farming conditions in each group in this experiment were similar to those in Example 1, and the difference was the salinity only. The results were shown in Table 2.

TABLE 2
The farming results of different salinity

| | 28 ppt | 29 ppt | 30 ppt | 34 ppt | 37 ppt | 38 ppt |
|---|---|---|---|---|---|---|
| Acropora | X | Δ | ◯ | ◯ | ◯ | Δ |
| formosa | | | | | | |
| Acropora | X | Δ | ◯ | ◯ | ◯ | Δ |
| nobilis | | | | | | |
| Acropora | X | Δ | ◯ | ◯ | ◯ | Δ |
| austere | | | | | | |
| Fimbriaphyllia | Δ | Δ | Δ | ◯ | Δ | Δ |
| ancora | | | | | | |

According to Table 2, when the salinity was 29 ppt or 38 ppt, Acropora formosa, Acropora nobilis and Acropora austere grew slowly. When the salinity was 30 ppt to 37 ppt, it was most suitable for the growth of Acropora formosa, Acropora nobilis and Acropora austere.

Experiment 3: Alkalinity

The farming conditions in each group in this experiment were similar to those in Example 1, and the difference was the alkalinity only. The results were shown in Table 3.

TABLE 3
The farming results of different alkalinity

| | 6 dKH | 7 dKH | 8.5 dKH | 10 dKH | 11 dKH |
|---|---|---|---|---|---|
| Acropora | X | ◯ | ◯ | ◯ | X |
| formosa | | | | | |
| Acropora | X | ◯ | ◯ | ◯ | X |
| nobilis | | | | | |
| Acropora | X | ◯ | ◯ | ◯ | X |
| austere | | | | | |
| Fimbriaphyllia | X | ◯ | ◯ | X | X |
| ancora | | | | | |

According to Table 3, when the alkalinity was 7 dKH to 10 dKH, it was most suitable for the growth of Acropora formosa, Acropora nobilis and Acropora austere.

Experiment 4: Temperature

The farming conditions in each group in this experiment were similar to those in Example 1, and the difference was the temperature only. The results were shown in Table 4.

TABLE 4
The farming results of different temperatures

| | 19° C. | 20° C. | 23° C. | 26° C. | 27° C. |
|---|---|---|---|---|---|
| Acropora | Δ | ◯ | ◯ | ◯ | X |
| formosa | | | | | |
| Acropora | Δ | ◯ | ◯ | ◯ | X |
| nobilis | | | | | |
| Acropora | Δ | ◯ | ◯ | ◯ | X |
| austere | | | | | |
| Fimbriaphyllia | ◯ | ◯ | ◯ | X | X |
| ancora | | | | | |

According to Table 4, when the temperature was 20° C. to 26° C., it was most suitable for the growth of Acropora formosa, Acropora nobilis and Acropora austere.

Experiment 5: The Concentration of the Magnesium Ions

The farming conditions in each group in this experiment were similar to those in Example 1, and the difference was the concentration of the magnesium ions only. The results were shown in Table 5.

TABLE 5
The farming results of different concentration
of the magnesium ions

| | 1050 | 1290 | 1395 | 1500 | 1700 |
|---|---|---|---|---|---|
| | ppm | ppm | ppm | ppm | ppm |
| Acropora formosa | Δ | ◯ | ◯ | ◯ | X |
| Acropora nobilis | Δ | ◯ | ◯ | ◯ | X |
| Acropora austere | Δ | ◯ | ◯ | ◯ | X |
| Spinal wheat soft | Δ | ◯ | ◯ | Δ | X |
| coral | | | | | |

According to Table 5, when the concentration of the magnesium ions was 1290 ppm to 1500 ppm, it was most suitable for the growth of Acropora formosa, Acropora nobilis and Acropora austere. Besides, when the concentration of the magnesium ions was 1050 ppm, the colors of Acropora formosa, Acropora nobilis and Acropora austere faded.

Experiment 6: The Concentration of the Calcium Ions

The farming conditions in each group in this experiment were similar to those in Example 1, and the difference was the concentration of the calcium ions only. The results were shown in Table 6.

TABLE 6
The farming results of different concentrations of the calcium ions

| | 350 | 400 | 430 | 465 | 500 | 560 |
|---|---|---|---|---|---|---|
| | ppm | ppm | ppm | ppm | ppm | ppm |
| Acropora formosa | X | Δ | ◯ | ◯ | ◯ | X |
| Acropora nobilis | X | Δ | ◯ | ◯ | ◯ | X |
| Acropora austere | X | Δ | ◯ | ◯ | ◯ | X |
| Spinal wheat soft coral | X | Δ | ◯ | ◯ | Δ | X |

According to Table 6, when the concentration of the calcium ions was 430 ppm to 500 ppm, it was most suitable for the growth of Acropora formosa, Acropora nobilis and Acropora austere; wherein when the concentration of the calcium ions was 400 ppm, the growing rate of Acropora formosa, Acropora nobilis and Acropora austere slowed down.

Experiment 7: The Filtered Amount of the Seawater

The farming conditions in each group in this experiment were similar to those in Example 1, and the difference was the filtering rate, which was the filtered amount of the seawater per minute, only. The results were shown in Table 7.

TABLE 7
The farming results of different filtered amounts of the seawater

| | 2.5% | 3% | 4% | 5.56% |
|---|---|---|---|---|
| Acropora formosa | X | Δ | ◯ | ◯ |
| Acropora nobilis | X | Δ | ◯ | ◯ |
| Acropora austere | X | Δ | ◯ | ◯ |

Notes:
% means the volume percentage of the filtered amount of the seawater per minute based on the total volume of the seawater in the glass culturing tank, which did not include those in the water storage tank and the pipelines.

According to Table 7, when the filtered amount of the seawater was 4 volume percent to 5.56 volume percent, it was most suitable for the growth of Acropora formosa, Acropora nobilis and Acropora austere.

Experiment 8: The Concentration of Phosphate, Nitrate and Nitrite

The farming conditions in each group in this experiment were similar to those in Example 1, and the difference was the concentration of phosphate, nitrate and nitrite only. The results were shown in Table 8.

TABLE 8
The farming results of different concentrations
of phosphate, nitrate and nitrite

| | The concentration | | The concentration | | The concentration | |
|---|---|---|---|---|---|---|
| | of phosphate (ppm) | | of nitrate (ppm) | | of nitrite (ppm) | |
| | 0.029 | 0.031 | 0.49 | 0.51 | 0.090 | 0.110 |
| Acropora | ◯ | Δ | ◯ | Δ | ◯ | Δ |
| formosa | | | | | | |
| Acropora | ◯ | Δ | ◯ | Δ | ◯ | Δ |
| nobilis | | | | | | |
| Acropora | ◯ | Δ | ◯ | Δ | ◯ | Δ |
| austere | | | | | | |

According to Table 8, when the concentration of phosphate was less than 0.03 ppm, the concentration of nitrate was less than 0.5 ppm, and the concentration of nitrite was less than 0.1 ppm, it was most suitable for the growth of Acropora formosa, Acropora nobilis and Acropora austere.

Experiment 9: The Water Cleaning Module

The farming conditions in each group in this experiment were similar to Example 1, and the results were shown in Table 9; wherein the water cleaning module in Group A comprised biochemical cotton, a ceramic ring, a filter cotton, coral bone stones and live rock of coral reefs; the water cleaning module in Group B comprised biochemical cotton, a ceramic ring, a filter cotton, shell sand and live rock of coral reefs.

TABLE 9
The farming results of different water cleaning modules

| | Group A | Group B |
|---|---|---|
| Acropora formosa | ◯ | Δ |
| Acropora nobilis | ◯ | Δ |
| Acropora austere | ◯ | Δ |

According to Table 9, the filtering effect of Group A was excellent, so the growth of Acropora formosa, Acropora nobilis and Acropora austere was in good condition. The coral bone stones adopted in Group A was replaced with shell sand in Group B. As the filtering effect of Group B was relatively weak, the growth of Acropora formosa, Acropora nobilis and Acropora austere in Group B was not as ideal as that in Group A.

Experiment 10: Food

The farming conditions in each group in this experiment were similar to Example 1, and the results were shown in Table 10; wherein the food in Group C was paramecium; the food in Group D was small (S-type) rotifers and super small (SS-type) rotifers; and the food in Group E was Bdelloid rotifers.

TABLE 10
The farming results of different food

| | Group C | Group D | Group E |
|---|---|---|---|
| Acropora formosa | ◯ | ◯ | Δ |
| Sea crest coral | ◯ | Δ | ◯ |
| Fimbriaphyllia ancora | Δ | Δ | Δ |

According to Table 10, the growth of Acropora formosa in Groups C and D was in good condition, wherein the coral polyps were fat and beautiful and the formed coral bone was thicker and stronger. In comparison, the growth of Acropora formosa and Fimbriaphyllia ancora in Group E was relatively weak; wherein the coral polyps of Acropora formosa were tiny and the formed coral bone had a relatively slim shape. Accordingly, feeding with the food of paramecium, small (S-type) rotifers or super small (SS-type) rotifers facilitates the growth of Acropora formosa.

### Example 2: The Coral Farming System

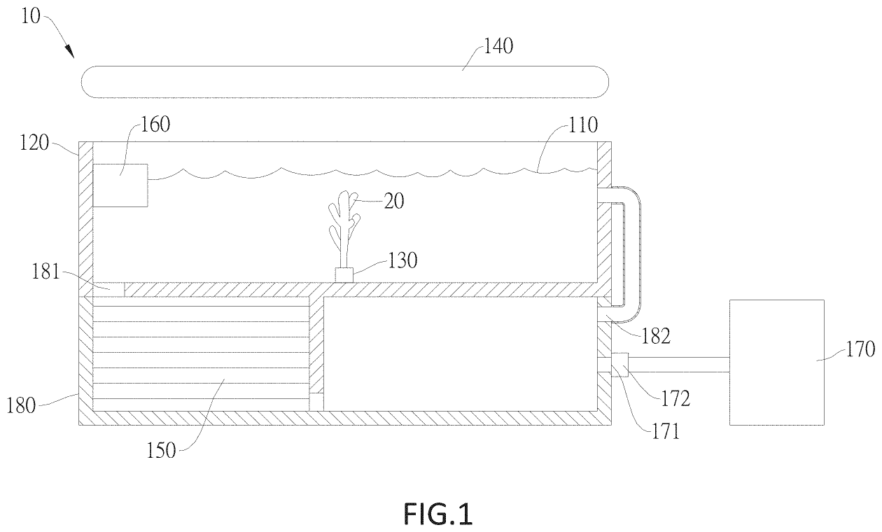

As shown in FIG. 1, the coral farming system 10, comprising: a seawater 110; a water tank 120, wherein the water tank 120 is used for containing the seawater 110, at least one base 130 is provided to the bottom in the water tank 120, the at least one base 130 is used for placing a coral 20, and based on the total volume of the seawater 110 in the water tank 120, the filtered amount of the seawater 110 is at least 2.6 volume percent per minute; a light source module 140, used for providing light to the coral 20 for at least 6 hours a day; a water cleaning module 150, used for filtering the seawater 110; a defoaming module 160, used for removing a floating foam of the seawater 110; a pure water supply module 170, used for supplying a pure water to supplement the seawater 110 and having a water supply outlet 171; and a water storage tank 180, having a water inlet 181 and a water outlet 182, wherein the water inlet 181 and the water outlet 182 each communicate to both the water tank 120 and the water storage tank 180, and the water supply outlet 171 communicates to both the pure water supply module 170 and the water storage tank 180.

The light source module 140 is provided above the surface of the seawater 110.

Preferably, the water storage tank 180 is set below the water tank 120 or the bottom of the water tank 120.

Preferably, the pure water supply module 170 further has a pure water outlet control module 172, used for opening or closing the water supply outlet 171, and the water supply outlet 171 is near the water outlet 182, and the water cleaning module 150 is contained in the water storage tank 180, and the water cleaning module 150 is near the water inlet 181.

The seawater flows by means of a water pump (not shown).

### Example 3: Corals

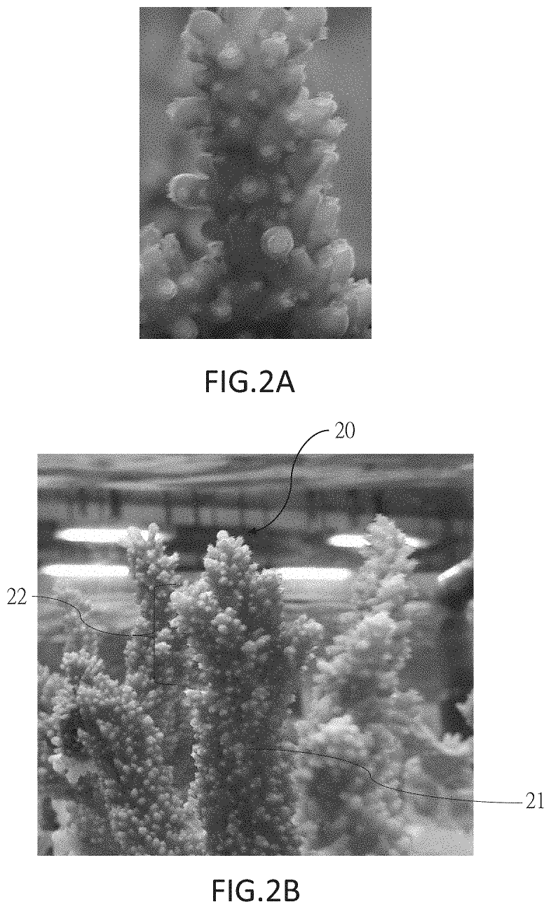

As shown in FIG. 2A, the branch of the corals shows the exoskeleton of the small polyp stony corals and coral polyps. As shown in FIG. 2B, the coral 20 has a main body 21 and branches 22.

### Example 4: The Coral Product

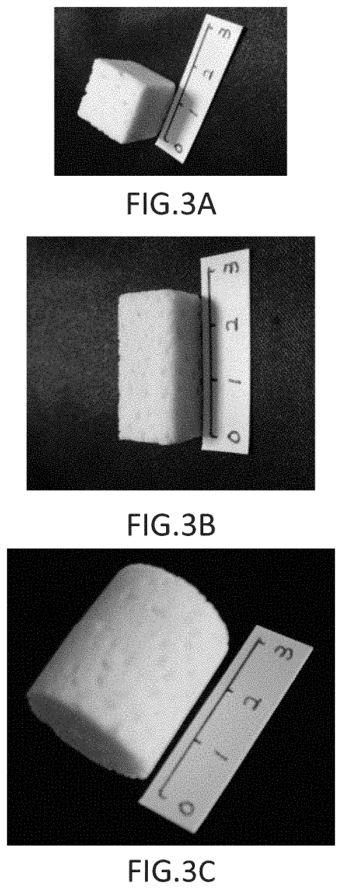

The coral product in this experiment can be a coral bone without chemical modification, and is a coral block of the coral bone. As shown in FIG. 3A, the coral block of the coral bone is a cube with a length, width and height of 1.3 cm, respectively. As shown in FIG. 3B, the coral block of the coral bone is a cuboid with a length of 2.5 cm, a width of 1.2 cm, and a height of 1 cm. As shown in FIG. 3C, the coral block of the coral bone is a cylinder with a height about 3 cm and a diameter of 2 cm.

### Example 5: Heavy Metals Test for the Coral Product

The coral product in this experiment was a coral bone without chemical modification, and was tested by SGS Taiwan Limited according to General Method of Test for Heavy Metals published in Ministry of Health and Welfare (MOHW) Food No. 1031901169, and Inductively coupled plasma-optical emission spectrometry (ICP-OES) was used for analysis. The results were shown in Table 11.

TABLE 11
Heavy metals test results of the coral product

| | | Quantitation/ | |
|---|---|---|---|
| Test item | Test result | detection limit | Unit |
| Arsenic (As) | not detected | 2.0 | ppm(mg/kg) |
| Lead (Pb) | not detected | 2.0 | ppm(mg/kg) |
| Cadmium (Cd) | not detected | 2.0 | ppm(mg/kg) |
| Mercury (Hg) | not detected | 2.0 | ppm(mg/kg) |
| Copper (Cu) | not detected | 2.0 | ppm(mg/kg) |
| Calcium (Ca) | 297170.8 | 2.0 | ppm(mg/kg) |
| Phosphorous (P) | 20.9 | 2.0 | ppm(mg/kg) |
| Magnesium (Mg) | 982.6 | 2.0 | ppm(mg/kg) |
| Potassium (K) | 83.2 | 2.0 | ppm(mg/kg) |
| Zinc (Zn) | not detected | 2.0 | ppm(mg/kg) |
| Iron (Fe) | 9.6 | 2.0 | ppm(mg/kg) |
| Manganese (Mn) | not detected | 2.0 | ppm(mg/kg) |
| Selenium (Se) | not detected | 2.0 | ppm(mg/kg) |
| Sodium (Na) | 3547.4 | 2.0 | ppm(mg/kg) |

According to Table 11, the test items for the coral product of the present invention comprise arsenic, lead, cadmium, mercury, copper, calcium, phosphorous, magnesium, potassium, zinc, iron, manganese, selenium and sodium, and based on the total weight of the obtained results for the test items, the calcium was in an amount of 98.46141 weight percent, the phosphorus was in an amount of 0.006925 weight percent, the magnesium was in an amount of 0.325564 weight percent, the potassium was in an amount of 0.027567 weight percent, the iron was in an amount of 0.003181 weight percent, and the sodium was in an amount of 1.175358 weight percent. The arsenic, lead, cadmium, mercury and copper were significantly toxic to organism and the amount thereof were all not detected, which indicated that the coral product of the present invention can be safe for humans. Finally, the selenium was also not detected.

### Example 6: Ingredient Analysis for the Coral Product

The coral product in this experiment was a coral bone without chemical modification, and was tested by Ultra Trace & Industrial Safety Hygiene Laboratory of SGS Taiwan Limited according to the certified internal method (TEST-UG-0435), and Inductively coupled plasma-optical emission spectrometry (ICP-OES) was used for analysis. The results were shown in Table 12.

TABLE 12
The ingredient analysis results of the coral product

| | | | Quantitation/ | |
|---|---|---|---|---|
| | | Test | detection | |
| Test item | CAS NO. | result | limit | Unit |
| Arsenic (As) | 7440-38-2 | not | 2.0 | ppm(mg/kg) |
| | | detected | | |
| Lead (Pb) | 7439-92-1 | not | 2.0 | ppm(mg/kg) |
| | | detected | | |
| Mercury (Hg) | 7439-97-6 | not | 2.0 | ppm(mg/kg) |
| | | detected | | |
| Cadmium (Cd) | 7440-43-9 | not | 2.0 | ppm(mg/kg) |
| | | detected | | |
| Magnesium (Mg) | 7439-95-4 | 807 | 2.0 | ppm(mg/kg) |
| Phosphorous (P) | 7723-14-0 | 28.8 | 10.0 | ppm(mg/kg) |
| Manganese (Mn) | 7439-96-5 | not | 2.0 | ppm(mg/kg) |
| | | detected | | |
| Zinc (Zn) | 7440-66-6 | not | 2.0 | ppm(mg/kg) |
| | | detected | | |
| Copper (Cu) | 7440-50-8 | not | 2.0 | ppm(mg/kg) |
| | | detected | | |
| Iron (Fe) | 7439-89-6 | 368 | 2.0 | ppm(mg/kg) |
| Potassium (K) | 7440-09-7 | 78.1 | 2.0 | ppm(mg/kg) |
| Sodium (Na) | 7440-23-5 | 4110 | 2.0 | ppm(mg/kg) |
| Calcium (Ca) | 7440-70-2 | 377000 | 100 | ppm(mg/kg) |
| Selenium (Se) | 7782-49-2 | not | 2.0 | ppm(mg/kg) |
| | | detected | | |
| Silicon (Si) | 7440-21-3 | 367 | 10.0 | ppm(mg/kg) |

According to Table 12, the test items for the coral product of the present invention gained silicon in comparison with those in Example 5, and based on the total weight of the obtained results for the test items, the calcium was in an amount of 98.49542 weight percent, the phosphorus was in an amount of 0.007524 weight percent, the magnesium was in an amount of 0.210838 weight percent, the potassium was in an amount of 0.020404 weight percent, the iron was in an amount of 0.096144 weight percent, the sodium was in an amount of 1.073783 weight percent, and the silicon was in an amount of 0.095883 weight percent. The arsenic, lead, cadmium, mercury and copper were significantly toxic to organism and the amount thereof were all not detected, which indicated that the coral product of the present invention can be safe for humans. Finally, the selenium was also not detected.

Besides, according to the comparison of Examples 5 and 6, although the test methods in Examples 5 and 6 may not necessarily be the same, the top three amounts of the elements in the coral product of the present invention were calcium, sodium and magnesium sequentially, and the total amount of calcium, sodium and magnesium was more than 99.5 weight percent; wherein calcium served as the main ingredient and was 98.46141 weight percent and 98.49542 weight percent in Examples 5 and 6, respectively. Therefore, the coral product of the present invention was rich in calcium ingredient, which was calcium carbonate and can served as the raw material for artificial bone substitute so as to demonstrate a market potential.

### Example 7: Compressive Strength Test

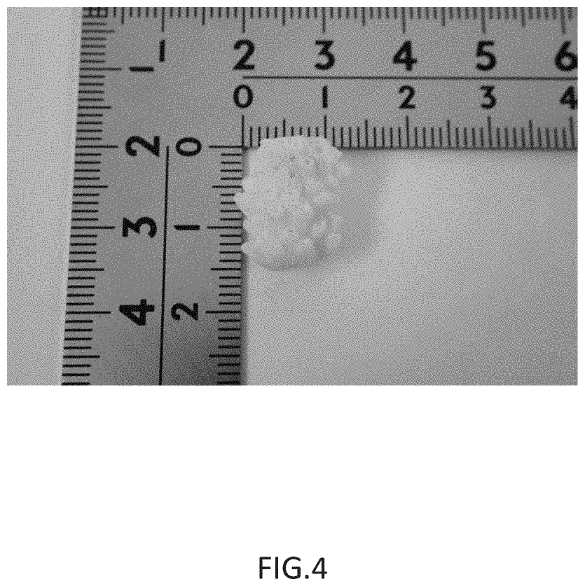

The coral product in this experiment was a coral bone without chemical modification, and served as the test sample with an average diameter of 10.1 millimeters (mm) and an average height of 15.1 mm as shown in FIG. 4. This test was carried out according to the Charter of 4.6.2.4 in the regulations of ISO 13175-3(2012), wherein the condition adjustments for the test sample comprised: 23±2□, a relative humidity of 50±10%, and a time more than 24 hours. The temperature in the laboratory was 23±2□, and the relative humidity thereof was 50±10%. The test speed was 0.50 millimeter per minute (mm/min). The equipment to test the test sample was MTS Criterion C43 Universal Testing Machine. The steel ball used in the test had a diameter of 12.7 mm. There were 10 test samples in total. The results were shown in Table 13.

TABLE 13
Maximum compressive load (Unit: kgf)

| A No. | Maximum compressive load (kgf) |
|---|---|
| #1 | 121 |
| #2 | 122 |
| #3 | 211 |
| #4 | 78.7 |
| #5 | 120 |
| #6 | 82.0 |
| #7 | 70.6 |
| #8 | 98.4 |
| #9 | 74.8 |
| #10 | 36.6 |
| Average | 102 |
| S.D. | 47 |

According to Table 13, the maximum compressive load of the present invention ranged from 36.6 kgf to 211 kgf. The average maximum compressive load was 102 kgf, which was an excellent maximum compressive load, that is, an excellent compressive strength and thereby was suitable for serving as the raw material for artificial bone substitute.

### Example 8: Analysis of the Diameter of the Pores

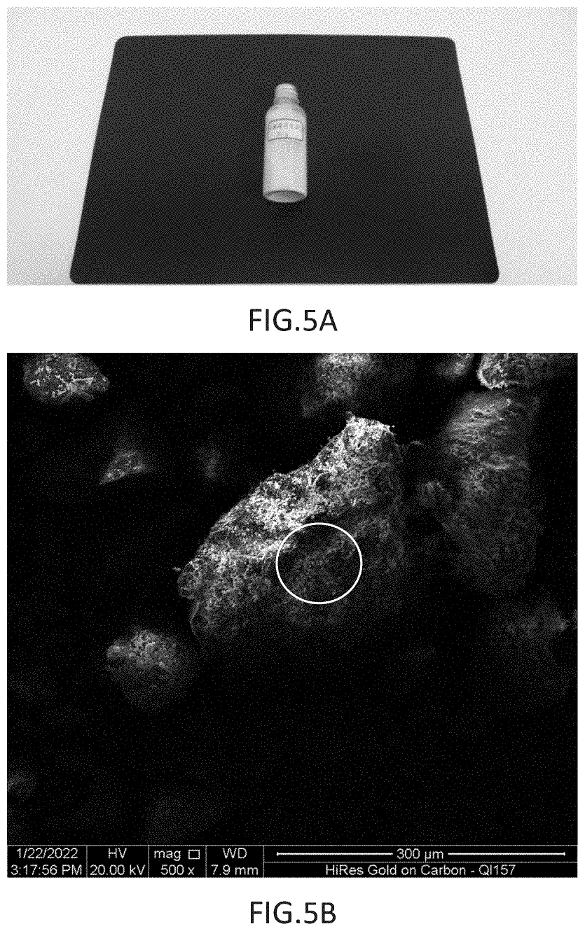

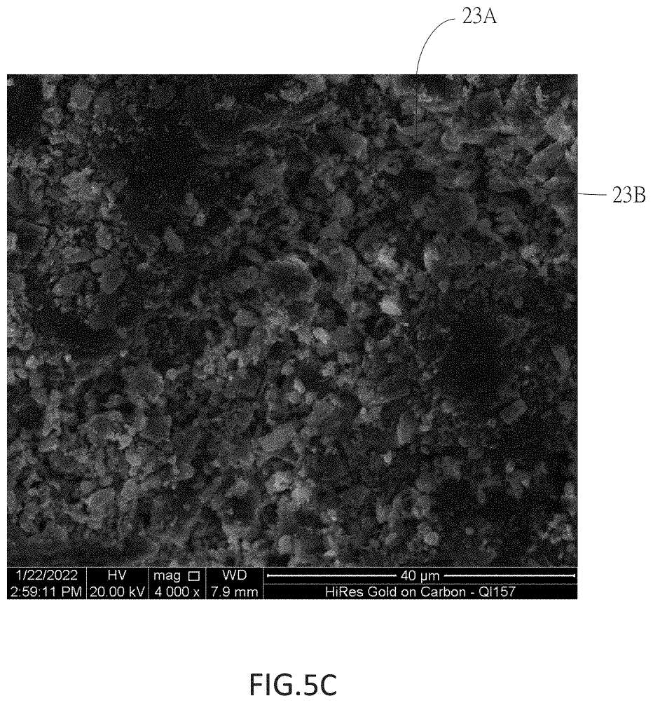

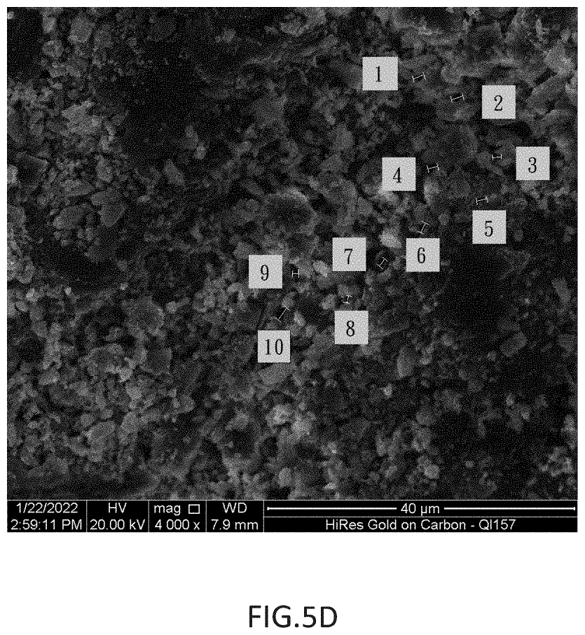

The coral product in this experiment was a coral bone without chemical modification, and the test sample was in the form of particles and was a white powder with an average diameter of 250 micrometers as shown in FIG. 5A. This test was carried out according to the regulations of ISO 13175-3(2012), and adopted a scanning electron microscope (brand name: Topcon; type: SM-300) to observe the pores and measure the diameter thereof. The 500× photo of a single particle was shown in FIG. 5B, and the site in the circle was magnified to 4000 times with a shooting angle of 0 degree along z-axis as shown in FIG. 5C. Further, 10 adjacent pores were selected at random to measure the diameters thereof as shown in FIG. 5D. The results were shown in Table 14.

TABLE 14
The diameter of the pores (Unit: micrometers (μm))

| No. | The diameter of the pores (μm) |
|---|---|
| #1 | 1.245 |
| #2 | 0.805 |
| #3 | 0.815 |
| #4 | 1.114 |
| #5 | 1.401 |
| #6 | 0.761 |
| A #7 | 0.805 |
| #8 | 0.660 |
| #9 | 0.510 |
| #10 | 1.637 |
| Average | 0.975 |
| S.D. | 0.359 |

According to Table 14, even the coral product of the present invention was ground into fine powders, as shown in the 4000× photo of FIG. 5C, the calcium carbonate secreted by coral polyps was in the form of particles, which connected and were stacked with each other, and formed the pores 23A, 23B as shown in FIG. 5C. The diameter of the pores ranged from 0.510 micrometers to 1.637 micrometers, and the average diameter of the pores was 0.975 micrometers. As the pores can be observed on the surface of the particles after grinding, the coral bone of the present invention without chemical modification indeed has complex inner interconnected channels. Therefore, if the coral bone without chemical modification of the present invention was used in the human body, these inner interconnected channels will facilitate the flow of active substances and nutrients so as to promote bone repairing.

### Example 9: Uniformity Deviation of the Pores

This example followed Example 8, and the distance between two centers of the respective two pores of the 10 pores in the 4000× field of view like those in the Example 8 was measured. The results were shown in Table 15.

TABLE 15
the distance between two centers of the respective
two pores (Unit: micrometers (μm))

| | The distance between two centers |
|---|---|
| No. | of the respective two pores (μm) |
| #1 to #2 | 5.572 |
| #2 to #3 | 9.074 |
| #3 to #4 | 8.242 |
| #4 to #5 | 7.779 |
| #5 to #6 | 8.381 |
| #6 to #7 | 6.93 |
| #7 to #8 | 6.341 |
| #8 to #9 | 7.592 |
| #9 to #10 | 5.142 |
| Average | 7.228 |
| S.D. | 1.331 |

According to Table 15, the average distance between the two centers of the respective two pores of the coral bone without chemical modification of the present invention was 7.228 μm, and the standard deviation thereof was 1.331 μm only, which indicated that the distance between the two centers of the respective two pores of the coral bone without chemical modification of the present invention had low degree of dispersion, that is, the pores of the coral bone without chemical modification of the present invention were distributed evenly, which may result from that the coral farming method of the present invention provided a stable growing environment to the small polyp stony corals to facilitate the stable growth of the coral bone to form an even distributed pores.

### Example 10: Phase Purity Analysis

The coral product in this experiment was a coral bone without chemical modification, and the test samples were the same as those in Example 8, which were powders as well. This test was carried out according to the Charter of 4.2 in ISO 13175-3(2012) for phase purity analysis. The equipment used was Multi Function High Power X-ray Diffractometer (Brand name: Bruker; Type: D8 Discover) and the angle range was 2θ from 20° to 80°.

The test result of the phase purity is that the crystallinity is 79.9%, and the amorphous is 20.1%. Therefore, the coral bone without chemical modification of the present invention comprised a high proportion of crystals, and such highly regular arrangement area can improve the mechanical strength.

To sum up, the farming method of the present invention can achieve mass production of small polyp stony corals effectively. As an indoor farming method is adopted, the concerns that small polyp stony corals may be subjected to marine pollution can be removed, and the obtained coral bone without chemical modification has no heavy metals, and has an excellent maximum compressive load, complex inner interconnected channels and low uniformity deviation of the pores, which facilitates the standardization of commodities, and can be applied to the medical field with high standards so as to demonstrate high market potential.

The examples are provided for the convenience of demonstration, and the embodiments shall not be used to limit the claim scope of the present invention. All alterations, modifications and other changes that do not deviate from the disclosure of the present invention shall be included within the claim scope covered by the present invention.

What is claimed is:

1. A coral farming method, comprising:
providing a water tank, wherein the water tank contains seawater, and the seawater has calcium ions and magnesium ions;
an inoculation step, comprising placing a coral on a base, and the base being placed in the water tank;
a cultivating step, comprising maintaining the seawater to have a pH of 7.8 to 8.8, a salinity of 29 parts per thousand (ppt) to 37 ppt, an alkalinity of 7 dKH to 10 dKH, and a temperature of 20° C. to 26° C., a calcium ions concentration of 430 ppm to 500 ppm, and a magnesium ions concentration of 1290 ppm to 1500 ppm;
a feeding step, comprising providing food to the coral;
an illuminating step, comprising providing light to the coral for at least 6 hours a day; and
a decontamination step, comprising removing a floating foam of the seawater and based on the total volume of the seawater in the water tank, filtering the seawater in an amount of at least 2.6 volume percent per minute; wherein the coral is a small polyp stony coral.

2. The coral farming method as claimed in claim 1, wherein the coral is selected from the group consisting of Acropora formosa, Acropora nobilis, Acropora austere, Acropora valenciennesi, Acropora pulchra, Acropora microphtha, Acropora intermedia and Acropora florida.

3. The coral farming method as claimed in claim 1, wherein the coral is a coral fragment, and the coral fragment comprises a calcium carbonate fragment and coral polyps; the calcium carbonate fragment has a length of 0.2 cm to 4 cm; and the base comprises a ceramic base plate or a cement plate.

4. The coral farming method as claimed in claim 1, wherein the seawater further comprises phosphate, nitrate and nitrite, and the concentration of the phosphate is 0 ppm or more and less than 0.03 ppm, the concentration of the nitrate is 0 ppm or more and less than 0.5 ppm, and the concentration of the nitrite is 0 ppm or more and less than 0.1 ppm.

5. The coral farming method as claimed in claim 1, wherein the food comprises a rotifer, paramecium or a combination thereof.

6. The coral farming method as claimed in claim 1, wherein based on the total volume of the seawater in the water tank, the filtered amount of the seawater is 2.6 volume percent per minute to 8.6 volume percent per minute.

7. A coral farming system, comprising:
a seawater, wherein the seawater has calcium ions and magnesium ions, and the seawater has a pH of 7.8 to 8.8, a salinity of 29 parts per thousand (ppt) to 37 ppt, an alkalinity of 7 dKH to 10 dKH, a temperature of 20° C. to 26° C., a calcium ions concentration of 430 ppm to 500 ppm, and a magnesium ions concentration of 1290 ppm to 1500 ppm;
a water tank, wherein the water tank is used for containing the seawater, at least one base is provided to the bottom in the water tank, the at least one base is used for placing a coral, and based on the total volume of the seawater in the water tank, the filtered amount of the seawater is at least 2.6 volume percent per minute;
a light source module, used for providing light to the coral for at least 6 hours a day;
a water cleaning module, used for filtering the seawater;
a defoaming module, used for removing a floating foam of the seawater;
a pure water supply module, used for supplying a pure water to supplement the seawater and having a water supply outlet; and
a water storage tank, having a water inlet and a water outlet, wherein the water inlet and the water outlet each communicate to both the water tank and the water storage tank, and the water supply outlet communicates to both the pure water supply module and the water storage tank.

8. The coral farming system as claimed in claim 7, wherein the storage volume ratio of the water tank and the water storage tank is 4 to 5:1.

9. The coral farming system as claimed in claim 7, wherein the water cleaning module comprises a biochemical cotton, a ceramic ring, a filter cotton, coral bone stones and live rock of coral reefs.

10. A coral product prepared by using a coral obtained from a coral farming method as claimed in claim 1, wherein the coral has a bone, and the coral product is obtained by processing the bone.

11. A coral product prepared by using a coral obtained from a coral farming system as claimed in claim 7, wherein the coral has a bone, and the coral product is obtained by processing the bone.

12. A coral product, comprising a calcium ingredient and a magnesium ingredient; and having a plurality of pores; wherein the calcium ingredient comprises calcium, the magnesium ingredient comprises magnesium, and based on the total amount of metal element and nonmetal element comprised in the coral product, the calcium is in an amount of 95 weight percent or more, the magnesium is in an amount of 1 weight percent or less, and the metal element comprises calcium, magnesium, potassium, iron and sodium, and the nonmetal element comprises phosphorus; and the coral product is obtained by processing small polyp stony corals.

13. The coral product as claimed in claim 12, wherein the coral product is a geometrical object with a length, width and height of 0.2 cm to 12 cm, respectively.

14. The coral product as claimed in claim 13, wherein the geometrical object is a cube with a length, width and height of 0.2 cm to 3.5 cm, respectively.

15. The coral product as claimed in claim 13, wherein the geometrical object is a cuboid with a length of 0.3 cm to 5 cm, a width of 0.2 cm to 3.5 cm; and a height of 0.2 cm to 3.5 cm.

16. The coral product as claimed in claim 13, wherein the geometrical object is a cylinder with a diameter of 0.2 cm to 3.5 cm, and a height of 0.5 cm to 7 cm.

17. The coral product as claimed in claim 12, wherein the standard deviation of the average distance between the two centers of the respective two pores of the coral product is less than half of the average distance between the two centers of the respective two pores.

18. The coral product as claimed in claim 12, wherein the average compressive strength of the coral product is 50 kgf to 200 kgf;

19. The coral product as claimed in claim 12, wherein the average diameter of the pore of the coral product is 0.5 μm to 1.7 μm; and the average distance between the two centers of the respective two pores of the coral product is 5 μm to 10 μm.

20. The coral product as claimed in claim 12, wherein the crystallinity of the coral product is 79% to 81%, and the amorphous thereof is 19% to 21%.
